(19) United States
(12) Patent Application Publication
(10) Pub. No.: US 2003/0038813 A1
(43) Pub. Date: Feb. 27, 2003

(54) Method of rendering a three-dimensional object using two-dimensional graphics

(76) Inventor: Kuang-Rong Lu, Kaohsiung (TW)

Correspondence Address: BIRCH STEWART KOLASCH & BIRCH, PO BOX 747, FALLS CHURCH, VA, 22040-0747, US

(21) Appl. No.: 10/225,429

(22) Filed: Aug. 22, 2002

(30) Foreign Application Priority Data
Aug. 23, 2001 (TW) 90120719

(51) Int. Cl. G09G 5/00

(52) U.S. Cl. 345/582

(57) ABSTRACT

A method of rendering a 3D object using 2D graphics. First, the user provides a closed curve, used to determine a polygon according to a resolution parameter. Based on the acquired polygon, a 3D frame is determined by creating a plurality of beveled planes adjacent to the sides of the polygon and a plurality of extrusive planes adjacent to the beveled planes according to at least one modeling parameter, which includes the bevel size, the bevel height and the extrusion length. Next, the beveled planes and the extrusive planes are sequentially filled by a linear gradient scheme with a color sequence produced by a 3D shading algorithm. Finally, a visible portion of the 3D frame and the filled extrusive planes and beveled planes is displayed on the display device.

### BACKGROUND OF THE INVENTION

1. Field of the Invention

The present invention relates in general to a computer graphics technology, more particularly to a method of rendering a three-dimensional (hereafter called 3D) object using two-dimensional (hereafter called 2D) graphics.

2. Description of the Related Art

Owing to the dissemination of computerized applications, computer graphics applications have been speedily developed, not only to perform various special effects, but also to render computer images with visual effects that could not be created before. In addition, the design of computer graphics can be applied to various fields due to the popularity of computers.

Generally speaking, the amount of data required in 2D graphics, compared with other applications such as video processing, is quite low. This makes 2D graphics a popular choice for a lot of bandwidth-sensitive communication applications, such as the Internet, Information Appliances (IAs), mobile phones, and personal digital agents (PDAs). Since the bandwidth of communication channels in these applications is strictly limited, the download or transmission speed increases inversely with the data amount and resulting file size.

However, the limitation of the conventional 2D graphics technology is that 3D objects cannot be shown. 3D graphics technology cannot be directly applied to the above-mentioned applications since it requires transmitting a lot of image data.

### SUMMARY OF THE INVENTION

An object of the present invention is to provide a method of rendering a 3D object using 2D graphics, which can be applied to bandwidth-sensitive applications due to smaller file size and thus exhibit 3D objects without the need of 3D graphics.

According to the above object, the present invention provides a method of rendering a 3D object in 2D graphics, applied in a computer system with a display device. First, the user provides a closed curve, used to determine a polygon according to a resolution parameter. The vertices of the polygon are located at the closed curve. Based on the acquired polygon, a 3D frame is determined by creating a plurality of beveled planes adjacent to sides of the polygon and a plurality of extrusive planes adjacent to the beveled planes according to at least one modeling parameter, which includes the bevel size, the bevel height and the extrusion length in the preferred embodiment. Next, the beveled planes and the extrusive planes are sequentially filled by a linear gradient scheme with a color sequence produced by a 3D shading algorithm. Finally, a visible portion of the 3D frame and the filled extrusive planes and beveled planes is displayed on the display device.

In addition, the formation of the 3D frame is performed by the following steps. First, several first beveled planes, adjacent to the sides of the polygon, are determined by the bevel size and the bevel height. Next, the extrusive planes adjacent to the first beveled planes are determined by the extrusion length. Finally, several second beveled planes adjacent to the extrusive planes are also determined by the bevel size and the bevel height. The other sides of the second beveled planes constitute a rear polygon. Thus, the 3D frame is defined according to the polygon determined by the closed curve.

In addition, the filling step further includes the following. First, one of the beveled planes and the extrusive planes is chosen as a selected plane. Then the selected plane is divided into a first triangle and a second triangle with a common side shared with the first triangle. Next, the first linear gradient vector corresponding to the first triangle and the second linear gradient vector corresponding to the second triangle are respectively determined. The color sequence is determined by segmenting the common side by a plurality of segmenting points and determining the color sequence of the segmenting points by the three-dimensional shading algorithm. Finally, using the first and second linear gradient vectors, the first and second triangles are filled with the color sequence, respectively. Accordingly, the filling operation of these planes can be sequentially performed.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram illustrating the linear gradient function adopted in the present invention;

FIG. 2 is a flowchart of rendering a 3D object using 2D graphics in accordance with the first embodiment of the present invention;

FIG. 3 is a flowchart of the detailed steps of the formation of the 3D frame in accordance with the first embodiment of the present invention;

FIG. 4 is a flowchart of the filling step in the first embodiment of the present invention;

FIG. 5 is a schematic diagram illustrating the process of generating a polygon from the closed curve in the first embodiment of the present invention;

FIG. 6 is a schematic diagram of a 3D frame in the first embodiment of the present invention;

FIGS. 7A, 7B and 7C illustrate the divided beveled and extrusive planes in the first embodiment of the present invention;

FIGS. 8A and 8B are schematic diagrams illustrating the determination of the linear gradient vectors pertaining to the triangles in the first embodiment of the present invention;

FIG. 9 is a schematic diagram of filling the beveled and extrusive planes by parallel lines in the first embodiment of the present invention;

FIG. 10 is a schematic diagram of filling the beveled and extrusive planes by concentric curves in the first embodiment of the present invention;

FIG. 11 is a schematic diagram illustrating the resulting 3D object in accordance with the first embodiment of the present invention;

FIG. 12 is a schematic diagram illustrating the 3D frame with concave curves in the second embodiment of the present invention;

FIG. 13 is a schematic diagram illustrating the 3D frame with convex curves in the second embodiment of the present invention;

FIG. 14 is a schematic diagram illustrating the filled 3D object after filling the 3D frame shown in FIG. 12; and

FIG. 15 is a schematic diagram illustrating the filled 3D object after filling the 3D frame shown in FIG. 13.

### DETAILED DESCRIPTION OF THE INVENTION

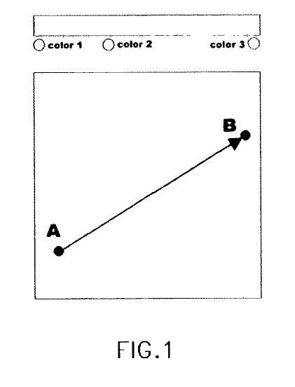

The present invention utilizes the linear gradient function in the rendering function of 2D graphics as a core of rendering 3D objects. The linear gradient function is briefly described before the present invention is fully illustrated herein. FIG. 1 is a diagram illustrating the linear gradient function. As shown in FIG. 1, the linear gradient function requires two sets of data, a linear gradient vector such as the vector connecting points A and B shown in FIG. 1 and a user-defined color sequence. The linear gradient vector is used to define the color-changing direction in the filling operation. If the selected color sequence is produced by the 3D shading scheme, the surface processed by the linear gradient scheme exhibits shading gradation as observed in 3D objects.

First Embodiment

The method of rendering a 3D object using 2D graphics in accordance with the first embodiment of the present invention is described as follows referring to the accompanying flowcharts and schematic diagrams.

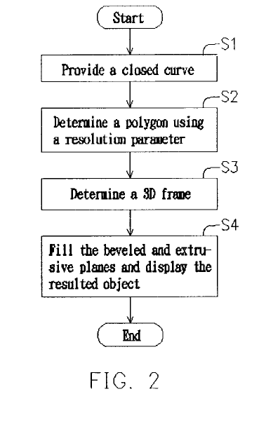

FIG. 2 is a flowchart of rendering a 3D object using 2D graphics in accordance with the first embodiment of the present invention. The user first determines a closed curve, used to generate a corresponding 3D frame (step S1). Next, the closed curve is used to produce a corresponding polygon according to a predefined resolution parameter (step S2). The effect of this step is shown in FIG. 5. In FIG. 5, numeral 1 represents a closed curve and numeral 3 represents a polygon corresponding to the closed curve 1. In addition the vertices of the polygon 3 are located at the closed curve 1. The higher the resolution is, the closer the closed curve 1 and the polygon 3 are. However, the user can also directly define a polygon, rather than a closed curve, to proceed with the following process. Thus, the steps S1 and S2 are not intended to limit the scope of the present invention.

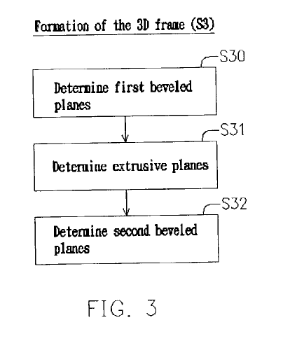

Next, the acquired polygon 3 is used to determine a corresponding 3D frame using several modeling parameters (step S3). In the present embodiment, the above-mentioned modeling parameters include: bevel size, bevel height and extrusion length. The bevel size is used to define the size of the beveled planes of the 3D frame adjacent to the polygon 3. The bevel height is used to define the height of beveled planes of the 3D frame adjacent to the polygon 3. The extrusion length is used to define the length of the extrusive planes of the 3D frame extended from the beveled planes. FIG. 6 is a schematic diagram illustrating the 3D frame in the first embodiment of the present invention, where numeral 10 represents a polygon front plane corresponding to the polygon 3 shown in FIG. 5 and numeral 20 represents a polygon rear plane. Between the polygon front plane 10 and the polygon rear plane 20, there are a plurality of first beveled planes 30 defined by the bevel size and the bevel height, a plurality of extrusive planes defined by the extrusion length, and a plurality of second beveled planes 50 defined by the bevel size and the bevel height. The detailed method of determining the 3D frame is shown in the flowchart of FIG. 3.

FIG. 3 is a flowchart illustrating the detailed steps of forming the 3D frame of step S3 in the present embodiment. First, the polygon 3 determined by the closed curve 1 is set as the polygon front plane 10. Next, the first beveled planes 30 adjacent to the polygon front plane 10 are determined using the bevel size and the bevel height (step S30). More specifically, each of the first beveled planes is generated by extending from each of the sides of the polygon front plane 10 by the bevel size and its inclined angle relative to the polygon front plane 10 is determined by the bevel height. As shown in the figure, each of the first beveled planes is a tetragon. Next, the extrusive planes 40 adjacent to the first beveled planes 30 are determined by extending from the sides of the first beveled planes 30 using the extrusion length (step S31). Each of the extrusive planes is also a tetragon. Next, the second beveled planes 50 are generated by extending from the sides of the extrusive planes 40 using the bevel size and the bevel height (step S32). Finally, the other sides of the second beveled planes constitute the polygon rear plane 20 opposite to the polygon front plane 10. Thus, the formation of the 3D frame shown in FIG. 6 is completed. Although the present embodiment employs the flowchart of FIG. 3 to form the 3D frame shown in FIG. 6, those skilled in the art can also utilize different processes to generate 3D frames of different types, which does not escape the scope of the present invention.

As shown in FIG. 2, after the formation of the 3D frame is completed, the beveled planes 30 and 50 and the extrusive planes 40 on the 3D frame are filled using the linear gradient scheme to complete the 3D object (step S4). As described above, the 3D frame generated in step S3 includes polygon front plane 10, polygon rear plane 20, beveled planes 30 and 50 and extrusive planes 40. The following discussion concentrates on the filling process of the beveled planes 30 and 50 and the extrusive planes 40, in the form of tetragons. In addition, the polygon front plane 10 and the polygon rear plane 20 can be filled with a single color or other filling schemes. The filling step 4 is discussed in detailed as follows.

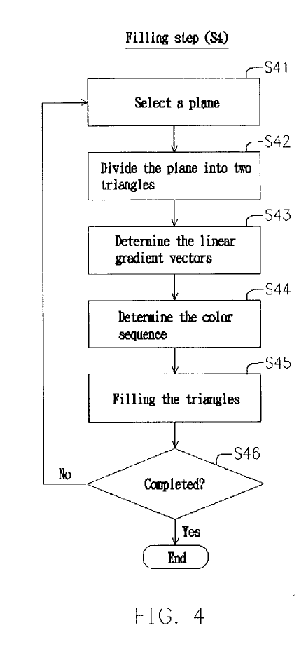

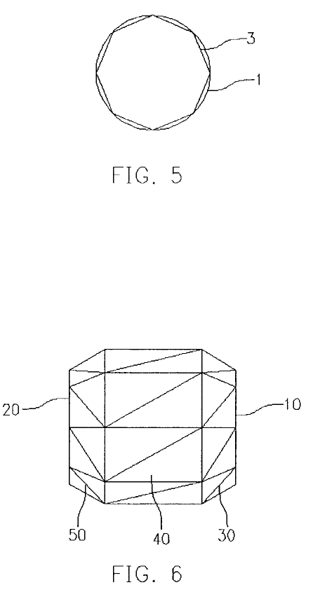

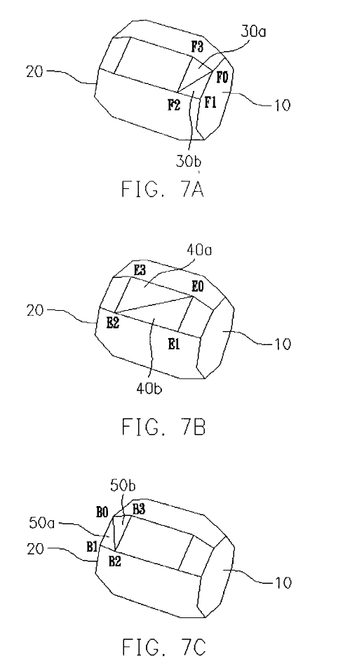

FIG. 4 is a flowchart illustrating the filling step S4 in the present embodiment. First, one of the beveled planes 30 and 50 and the extrusive planes 40 is selected as a selected plane, ready to be processed in the following steps (step S41). As described above, each of the beveled planes 30 and 50 and the extrusive planes 40 is a tetragon. Thus, the selected plane can be divided into two adjacent triangles (step S42). FIGS. 7A, 7B and 7C illustrate the divided planes 30, 40 and 50, respectively. In FIG. 7A, the bevel plane 30 adjacent to the polygon front plane 10 is divided into a triangle 30b, whose vertices are denoted by F₀, F₁ and F₂, and a triangle 30a, whose vertices are denoted by F₀, F₂ and F₃. In FIG. 7B, the extrusive plane 40 is divided into a triangle 40b, whose vertices are denoted by E₀, E₁ and E₂, and a triangle 40a, whose vertices are denoted by E₀, E₂ and E₃. In FIG. 7C, the bevel plane 50 adjacent to the polygon rear plane 20 is divided into a triangle 50a, whose vertices are denoted by B₀, B₁, and B₂, and a triangle 50b, whose vertices are denoted by B₀, B₂ and B₃.

Next, the two triangles are respectively filled by the linear gradient scheme. As described above, the linear gradient function requires two sets of data. One is the linear gradient vector and the other is the color sequence for filling. The first beveled plane 30 is used as an example in the following discussion. Other planes, such as extrusive planes 40 and the second beveled planes 50 can be processed by the same method.

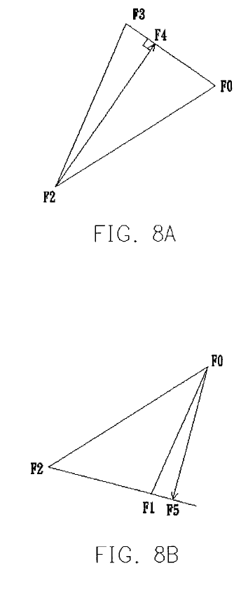

First, the linear gradient vectors pertaining to the triangles 30a and 30b of the beveled plane 30 are determined (step S43). FIG. 8A and FIG. 8B are schematic diagrams illustrating the determination of the linear gradient vectors pertaining to triangles 30a and 30b. In FIG. 8A, the vertices of triangle 30a are F₀, F₂ and F₃ and its side \overline{F₀F₂} is commonly owned by triangle 30b. The linear gradient vector of the triangle 30a is set to be vector \overline{F₂F₄}, where F₄ denotes a projection point of the vertex F₂ on the side \overline{F₀F₃} of triangle 30a. Similarly, as shown in FIG. 8B, the vertices of triangle 30b are F₀, F₁ and F₂ and its side \overline{F₀F₂} is also commonly owned by triangle 30a. The linear gradient vector of the triangle 30b is then set to be vector \overline{F₀F₅}, where F₅ denotes a projection point of the vertex F₀ on the side \overline{F₂F₃} of triangle 30b.

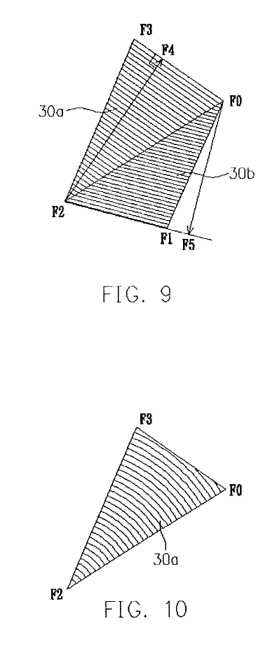

Subsequently, the color sequence is determined by the 3D shading algorithm (step S44). First, in the beveled plane 30, the common side, i.e. \overline{F₀F₂}, is segmented using a plurality of lines parallel with \overline{F₀F₃} in triangle 30a and a plurality of lines parallel with \overline{F₁F₂} to acquire multiple segmented points. As shown in FIG. 9, triangle 30a is divided into several pieces by the cutting lines parallel with its side \overline{F₀F₃}. In addition, triangle 30b is also divided into the same number of pieces by the cutting lines parallel with its side \overline{F₁F₂}. While the filled colors for points F₀ and F₂ are determined, the average colors of the segmenting points, which correspond to the divided pieces of triangles 30a and 30b, can be determined by the 3D shading algorithm to generate the required color sequence. In the present embodiment, the 3D shading algorithm is preferably the Phong illumination model. In the Phong illumination model, the resulting intensity I_{λ} of a color component represented by the symbol λ is expressed by:

I_{λ}=I_{aλ}K_{aλ}O_{dλ}+fₐₜₜI_{pλ}[K_{d}O_{dλ} cosθ+W(λ)cosⁿα

The Phong illumination model takes account of the ambient light effect, the diffuse reflection effect, light source attenuation and the specular reflection effect. In this model, I_{aλ} and I_{pλ} represent the intensity of the ambient light and the intensity of the diffuse-reflection light source, respectively, and K_{aλ} and K_{dλ}represent their coefficients. The parameter fₐₜₜ represents a light-source attenuation factor; O_{dλ} represents the diffused color of an object; θ represents the angle between the incident line and the normal line and α represents the view angle of the observer. According to the Phong illumination model, the color sequence for filling the triangles 30a and 30b is determined. In addition, since the color sequence involves the 3D shading effect, the filled 3D frame can exhibit the visual effect of a 3D object. In addition, the Phong illumination model in the present embodiment is not intended to limit the scope of the present invention. Other 3D shading schemes can also be applied to the present invention.

After the linear gradient vectors and the color sequence for filling in respect of triangles 30a and 30b are determined, the triangles 30a and 30b are filled by the linear gradient scheme (step S45). After the processing of the current plane is completed, the system examines if there are other unfilled beveled planes or extrusive planes (step S46). If the unfilled planes exist, the process will return back to step S41. If all planes are filled, the filling operation is completed.

Finally, a visible portion of the resulting 3D frame including the filled bevel planes and extrusive planes is displayed on the monitor of a graphics system. The process of rendering the 3D object using 2D graphics is completed.

In addition, in the present embodiment, the linear gradient function is achieved by filling the planes in terms of parallel lines arranged along the linear gradient vector, not intended to limit the scope of the present invention. For example, the filling step can be performed in terms of concentric curves like those shown in FIG. 10. As shown in FIG. 10, the filling operation of the triangle 30a starts from the point F₂ and fills the triangle 30a along the concentric curves according to the predetermined color sequence, in the direction of the side \overline{F₀F₃}.

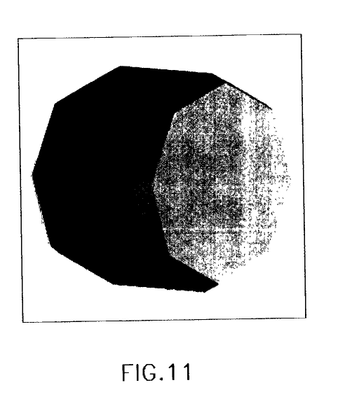

FIG. 11 is a schematic diagram illustrating the resulting 3D object in accordance with the first embodiment of the present invention. As described above, the feature of the present invention is to utilize 2D graphics techniques to render a 3D object. Accordingly, the advantage of the 2D graphics, such as small file size, can be maintained and the display with 3D effect can be obtained.

Second Embodiment

In the first embodiment, the sides of the beveled or extrusive planes of the 3D frame are straight lines. The present embodiment illustrates the processing method when the sides of the beveled or extrusive planes are curves.

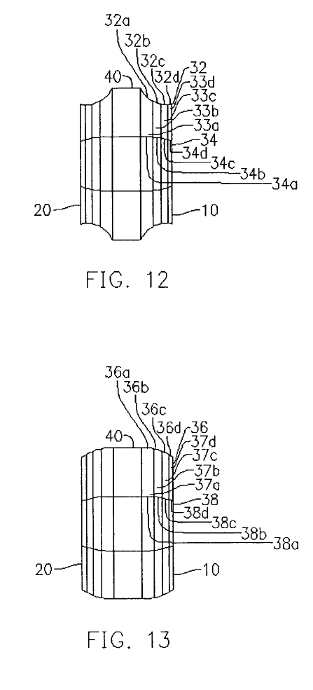

FIG. 12 is a schematic diagram illustrating the 3D frame with concave curves in the present embodiment of the present invention. As shown in FIG. 12, the method of the present embodiment segments the concave curves 32 and 34 to a plurality of straight lines 32a-32d and 34a-34d, respectively. Thus, the original beveled plane 30 is divided into four beveled sub-planes 33a-33d, each of a tetragon. The following filling steps, the same as those described in the first embodiment, sequentially fill the beveled sub-planes 33a-33d.

In addition, FIG. 13 is a schematic diagram illustrating the 3D frame with convex curves in the present embodiment of the present invention. As shown in FIG. 13, the method of the present embodiment segments the convex curves 36 and 38 to a plurality of straight lines 36a-36d and 38a-38d, respectively. Thus, the original beveled plane 30 is divided into four beveled sub-planes 37a-37d, each of a tetragon. The following filling steps, the same as those described in the first embodiment, sequentially fill the beveled sub-planes 37a-37d.

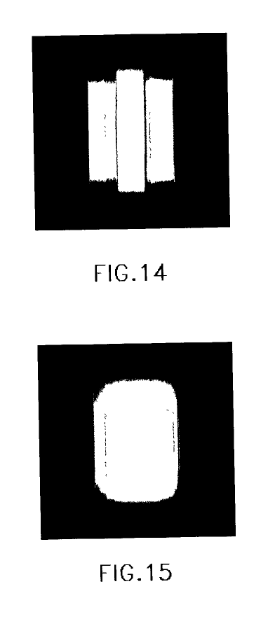

FIG. 14 and FIG. 15 are schematic diagrams of resulted 3D objects using the 3D frames shown in FIG. 12 and FIG. 13, respectively. As shown in these figures, the sides of the simulated 3D objects are curves, which can be applied to render various types of 3D objects. In addition, the curved sides of the extrusive planes can also be processed by the above-mentioned schemes and will not be described again.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of rendering a three-dimensional object in two-dimensional graphics applied in a computer system with a display device, comprising:
providing a closed curve;
determining a polygon corresponding to the closed curve, at which vertices of the polygon are located, according to a resolution parameter;
defining a three-dimensional frame by creating a plurality of beveled planes adjacent to sides of the polygon and a plurality of extrusive planes adjacent to the beveled planes according to a modeling parameter;
sequentially filling the beveled planes and the extrusive planes by a linear gradient scheme with a color sequence produced by a three-dimensional shading algorithm; and
displaying a visible portion of the three-dimensional frame and the filled extrusive planes and beveled planes on the display device.

2. The method of claim 1, wherein the modeling parameter includes bevel size, bevel height, and extrusion length.

3. The method of claim 2, wherein the step of defining the three-dimensional frame further comprises:
generating a plurality of first beveled planes adjacent to the sides of the polygon according to the bevel size and the bevel height;
generating the extrusive planes adjacent to the first beveled planes according to the extrusion length; and
generating a plurality of second beveled planes adjacent to the extrusive planes according to the bevel size and the bevel height, sides of which constitute a rear polygon.

4. The method of claim 3, wherein one of the first beveled planes, the extrusive planes and the second beveled planes is set as a selected plane and the selected plane has a curved side, further comprising the steps of:
segmenting the curved side to a plurality of straight lines; and
dividing the selected plane into a plurality of sub-planes, each of which includes one of the segmented straight lines and is a tetragon.

5. The method of claim 1, wherein the step of filling the beveled planes and the extrusive planes comprises:
choosing one of the beveled planes and the extrusive planes as a selected plane;
dividing the selected plane into a first triangle and a second triangle with a common side shared with the first triangle;
determining a first linear gradient vector corresponding to the first triangle and a second linear gradient vector corresponding to the second triangle, respectively;
determining a color sequence on the common side using the three-dimensional shading algorithm;
filling the first triangle with the color sequence according to the first linear gradient vector; and
filling the second triangle with the color sequence according to the second linear gradient vector.

6. The method of claim 5, wherein the steps of filling the first and second triangles are performed by filling the first and second triangles along a plurality of straight lines across the first and second triangles.

7. The method of claim 5, wherein the steps of filling the first and second triangles are performed by filling the first and second triangles along a plurality of concentric curves across the first and second triangles.

8. The method of claim 5, further comprising a step of filling the polygon.

9. The method of claim 5,
wherein the selected plane has a first vertex, a second vertex, a third vertex and a fourth vertex;
wherein vertices of the first triangle are the first vertex, the second vertex and the third vertex and vertices of the second triangle are the first vertex, the third vertex and the fourth vertex;
wherein the first linear gradient vector is a vector from the first vertex to a first projection point of the first vertex on the side connecting the second and third vertices; and
wherein the second linear gradient vector is a vector from the third vertex to a second projection point of the third vertex on the side connecting the first and fourth vertices.

10. The method of claim 5, wherein the step of determining the color sequence is performed by segmenting the common side by a plurality of segmenting points and determining the color sequence of the segmenting points by the three-dimensional shading algorithm.

11. A method of rendering a three-dimensional object in two-dimensional graphics applied in a computer system with a display device, comprising:
providing a polygon with a plurality of sides;
defining a three-dimensional frame by creating a plurality of beveled planes adjacent to sides of the polygon and a plurality of extrusive planes adjacent to the beveled planes according to a modeling parameter;
sequentially filling the beveled planes and the extrusive planes by a linear gradient scheme with a color sequence produced by a three-dimensional shading algorithm; and
displaying a visible portion of the three-dimensional frame and the filled extrusive planes and beveled planes on the display device.

12. The method of claim 11, wherein the step of filling the beveled planes and the extrusive planes comprises:
choosing one of the beveled planes and the extrusive planes as a selected plane;
dividing the selected plane into a first triangle and a second triangle with a common side shared with the first triangle;
determining a first linear gradient vector corresponding to the first triangle and a second linear gradient vector corresponding to the second triangle, respectively;
determining a color sequence on the common side using the three-dimensional shading algorithm;
filling the first triangle with the color sequence according to the first linear gradient vector; and
filling the second triangle with the color sequence according to the second linear gradient vector.

13. The method of claim 12, wherein the steps of filling the first and second triangles are performed by filling the first and second triangles along a plurality of straight lines across the first and second triangles.

14. The method of claim 12, wherein the steps of filling the first and second triangles are performed by filling the first and second triangles along a plurality of concentric curves across the first and second triangles.

15. The method of claim 12, further comprising a step of filling the polygon.

16. The method of claim 12,
wherein the selected plane has a first vertex, a second vertex, a third vertex and a fourth vertex;
wherein vertices of the first triangle are the first vertex, the second vertex and the third vertex and vertices of the second triangle are the first vertex, the third vertex and the fourth vertex;
wherein the first linear gradient vector is a vector from the first vertex to a first projection point of the first vertex on the side connecting the second and third vertices; and
wherein the second linear gradient vector is a vector from the third vertex to a second projection point of the third vertex on the side connecting the first and fourth vertices.

17. The method of claim 12, wherein the step of determining the color sequence is performed by segmenting the common side by a plurality of segmenting points and determining the color sequence of the segmenting points by the three-dimensional shading algorithm.

18. A method of filling a tetragon plane on a three-dimensional frame, comprising the steps of:
dividing the tetragon plane into a first triangle and a second triangle with a common side shared with the first triangle;
determining a first linear gradient vector corresponding to the first triangle and a second linear gradient vector corresponding to the second triangle, respectively;
determining a color sequence on the common side using a three-dimensional shading algorithm;
filling the first triangle with the color sequence according to the first linear gradient vector; and
filling the second triangle with the color sequence according to the second linear gradient vector.

19. The method of claim 18,
wherein the tetragon plane has a first vertex, a second vertex, a third vertex and a fourth vertex;
wherein vertices of the first triangle are the first vertex, the second vertex and the third vertex and vertices of the second triangle are the first vertex, the third vertex and the fourth vertex;
wherein the first linear gradient vector is a vector from the first vertex to a first projection point of the first vertex on the side connecting the second and third vertices; and
wherein the second linear gradient vector is a vector from the third vertex to a second projection point of the third vertex on the side connecting the first and fourth vertices.

20. The method of claim 18, wherein the step of determining the color sequence is performed by segmenting the common side by a plurality of segmenting points and determining the color sequence of the segmenting points by the three-dimensional shading algorithm.
